(19) United States
(12) Patent Application Publication
(10) Pub. No.: US 2007/0183652 A1
(43) Pub. Date: Aug. 9, 2007

(54) Method for detecting a code with the aid of a mobile station

(75) Inventors: Christer Backstrom, Espoo (FI); Caj Sodergard, Nakinkaari (FI)

Correspondence Address: BIRCH STEWART KOLASCH & BIRCH, PO BOX 747, FALLS CHURCH, VA, 22040-0747, US

(73) Assignee: Valtion Teknillinen Tutkimuskeskus, Espoo (FI)

(21) Appl. No.: 11/629,820

(22) PCT Filed: Jun. 17, 2005
(86) PCT No.: PCT/FI05/00291

§ 371 Date: Mar. 29, 2007

(30) Foreign Application Priority Data
Jun. 18, 2004 (FI) 20040858

(51) Int. Cl. G06K 9/00

(52) U.S. Cl. 382/154

(57) ABSTRACT

The invention relates to a method for detecting a code (40), and a mobile station adapted to the method. In the method, the mobile station (50) is used to capture an image of the subject (40) and the image is analysed and decoded into a numerical form in the mobile station (50). According to the invention, before the decoding of the bar code in the mobile station the edges of the subject (40) are determined from a high-resolution image, in the case of a 2D code, the location of the corner point of the subject (49) are estimated on the basis of adaptive thresholding, and in the case of a 2D code, a perspective transformation is formed.

The present invention relates to a method, according to the preamble of claim 1, for detecting a code with the aid of a mobile station.

The invention also relates to a mobile station and a computer program product.

According to the prior art, camera telephones are known, which can be used to detect bar codes from various products and use this bar code to connect the mobile station to product information on the product, with the aid of telecommunications connections.

A drawback of the prior art is that the detection event is time consuming and the end result often uncertain. The user may have to try several times before reading succeeds, which does not motivate the user. The uncertainty of the reading increases, if the code sign is not read in precisely the correct direction.

Most known technologies demand the user to actively capture an image of the code by pressing a key. This clearly makes the service more labourious to use.

In devices of the prior art, the user is given insufficient indication of the success of the reading. Thus the reading event remains vague and slow, in which case the power consumption of the reading device also increases during the reading event.

The invention is intended to eliminate the defects of the prior art described above and for this purpose create an entirely new type of method for detecting a code and a mobile station for this purpose.

The invention is based on automatic, real-time image analysis, which decides when the camera is sufficiently well positioned to successfully interpret the code. By means of this method, a bar code can even be read successfully in difficult conditions, for instance, from a slanting direction, under poor lighting, and on shiny objects. In addition, the interface of the invention is implemented in such a way that it tells the user of the current stage of the imaging situation and instructs them how to proceed. Based on the instruction, the user can very easily set the camera telephone at the correct distance from the imaging subject. In addition, in one preferred embodiment of the invention, the software controls the lens arrangement of a camera telephone equipped with zoom optics, in such a way that the optimal magnification ratio is found automatically. Thus the usability is further improved, because the user does not have to search for the correct imaging distance—it is enough for the code to be visible to the camera.

More specifically, the method according to the invention is characterized by what is stated in the characterizing portions of claims 1 and 8.

The mobile station according to the invention is, in turn, characterized by what is stated in the characterizing portions of claims 15 and 22.

Considerable advantages are gained with the aid of the invention.

The method according to the invention seeks for the optimal imaging distance, so that the imaging situation is not as demanding as in solutions according to the prior art. An acceptable image is obtained even if the code to be read is tilted relative to the camera. In addition, neither poor lighting nor shiny codes will prevent successful interpretation because, in the case of a 1D code, the algorithm retrieves the best out of hundreds of horizontal image lines. In addition, the imaging situation is facilitated, as the user is given real-time instructions for finding a suitable imaging distance and is informed of the success of the imaging situation.

In the following, the invention is examined with the aid of examples and with reference to the accompanying drawings.

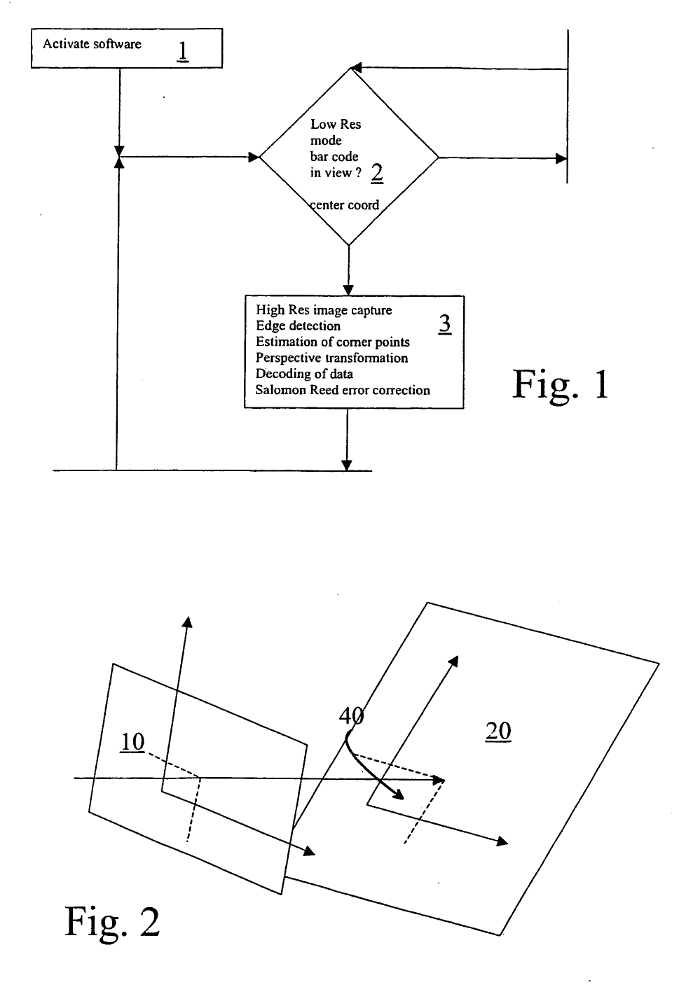

FIG. 1 shows a flow diagram of the method according to the invention.

FIG. 2 shows a perspective view of a problem situation according to the invention.

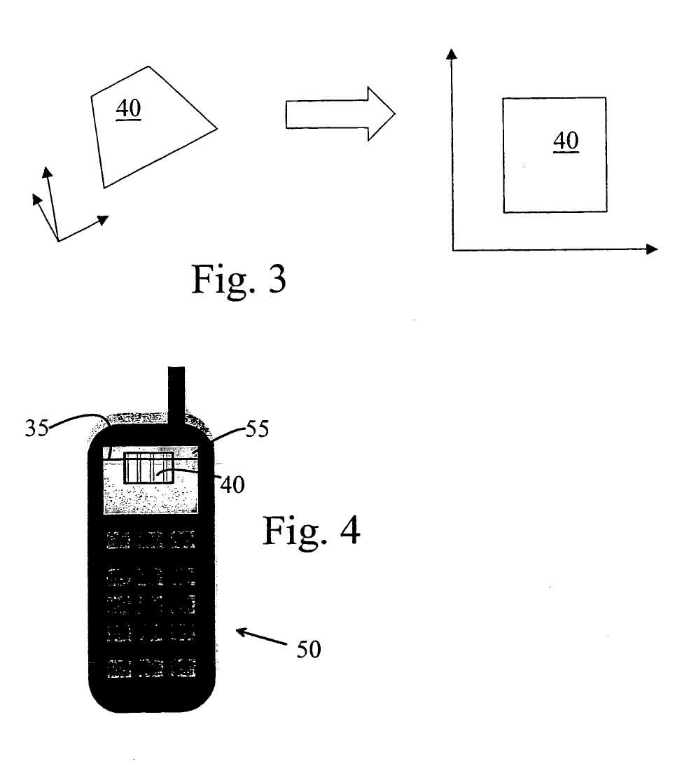

FIG. 3 shows a perspective view of a second problem situation according to the invention.

FIG. 4 shows the interface according to the invention

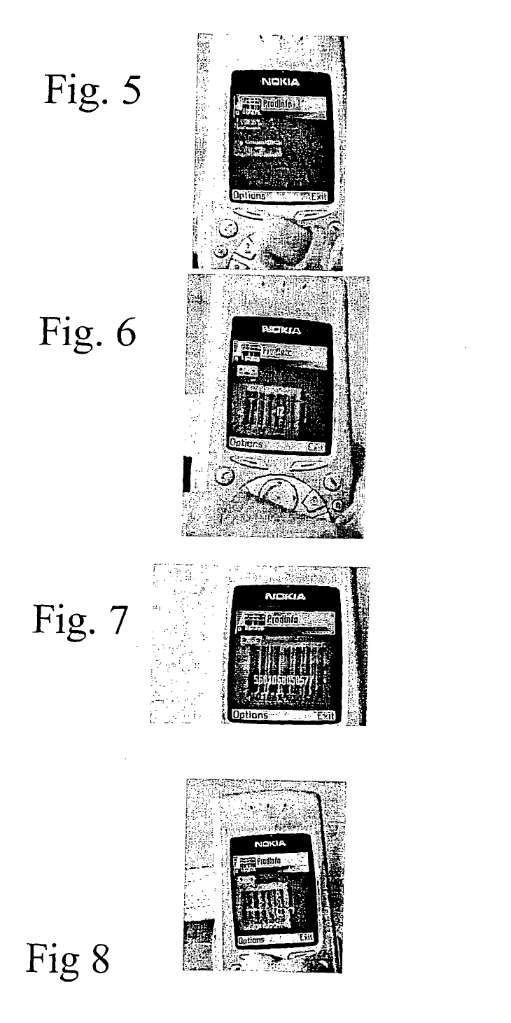

FIGS. 5-8 show photographs of the interface according to the invention.

The invention exploits the cameras, which are typically according to the VGA standard, in present-day mobile stations. One application according to the invention is implemented using the Symbian Series 60 software platform. Using this application according to the invention, both one-dimensional bar codes and two-dimensional matrix codes can be read.

One purpose of the invention is to provide a method and means for data search that takes place with the aid of product codes. In this case, the code is read using a mobile station. The numerical form of the code connects the mobile station over a communications network to a databank, from which the background data relating to the read code can be found. The mobile station can contain a preset user profile, so that always only information that interests the user will be retrieved according to the user's profile. The user profile can target, for example, some property of feedstuffs, such as calorie content, salt content, or some other health-related factor. The information retrieved over the telecommunications network is displayed to the user by means of the display of the mobile station.

The functionality according to the invention can be implemented, for example, in existing cameras, purely with the aid of software. In some cases, the optics may need changes, to allow close-up reading to succeed with sufficient accuracy. The change in the optics can be, for example, an extra lens in front of the normal optics. The new-generation variable-focal-length lenses can be applied as such to the solution of the invention.

In the manner of implementation according to the invention, detection takes place in the actual mobile station. In solutions according to the prior art, implementations are also known, in which the code is sent as such for analysis, i.e. as image data, over a telecommunications network. This procedure strains telecommunications networks and, at existing data-transfer speeds, is a form of operation that is slow and quite difficult to use.

The solution according to the invention is fully automatic once the imaging subject has been found.

The operational module of the camera determines when the code, for example a bar code, is within the camera's field of vision. If the camera has zoom optics, the optics are guided to the optimal magnification ratio. After this, the camera captures a full-size colour-VGA image, analyses it and decodes the contents of the code, for example a bar code. The contents can be a network address, product number, or, for example, a service request.

According to FIG. 1, the module according to the invention is activated in stage 1, for example, by selecting a suitable functional icon on the display of the mobile station. After activation 1, the mobile station begins to analyse the image continuously in a lower-resolution (SIF) operating state and to search for code signs, such as a bar code in block 2. If controllable zoom-optics are found, a suitable magnification ratio is automatically sought. Once the identifying signs of a bar code are found and the conditions for successful imaging are realized, the module changes the camera to a higher resolution state (VGA), captures an image, and analyses the contents of the code according to block 3. In block 3, detection of the edge of the code, estimation of the location of the corner points, perspective transformation, code-data decoding, and Salomon Reed error correction are carried out.

Once an image of the code 40, such as a bar code, has been captured according to FIG. 2, it is nearly impossible to position the camera in such a way that the camera's image place would be parallel to the plane 20 of the code 40. For the planes to be parallel, the optical axis of the camera would have to be aligned precisely at right angles to the plane 20 of the code. For a normal user this almost an impossible task. FIG. 2 shows this problem field and depicts the corrected image plane 10 relative to the code plane 20.

In the case of a 1D code, the descriptors of the bar code are calculated in real time, along horizontal segments of the image. Once the descriptors exceed a threshold, a change is made to a higher resolution form and the high-resolution image is examined. The error check in the 1D code ensures the correct result of the interpretation.

The defining of the imaging of each point of the corrected image plane 10, relative to the plane 20 of the code, such as a bar code 40, requires the solution of the following homogeneous system of equations:

$$[ \begin{matrix}XW \\ YW \\ W\end{matrix} ] = [ \begin{matrix}abc \\ def \\ gh 1\end{matrix} ] [ \begin{matrix}x \\ y \\ 1\end{matrix} ] \qquad ( 1 )$$

X and Y represent the co-ordinates of the image plane 10 while x and y for their part represent the co-ordinates of the plane 20 or the code 40. In order to determine the unknown coefficients, the system of equations is rearranged, so that the following group of equations is obtained:

$$[ \begin{matrix}a \\ b \\ c \\ d \\ e \\ f \\ g \\ h\end{matrix} ] = {[ \begin{matrix}xy 1000 - xX - yX \\ 000 xy 1 - xY - yY \\ xy 1000 - xX - yX \\ 000 xy 1 - xY - yY \\ xy 1000 - xX - yX \\ 000 xy 1 - xY - yY \\ xy 1000 - xX - yX \\ 000 xy 1 - xY - yY\end{matrix} ]}^{- 1} [ \begin{matrix}X \\ Y \\ X \\ Y \\ X \\ Y \\ X \\ Y\end{matrix} ] \qquad ( 2 )$$

This group of equations solved using four pairs of points from the image plane 10 and correspondingly from the code level 20, for example, the corner points of a two-dimensional code (trapezium).

Because the aim is to obtain the bar code as a square on the image plane 10 from the trapezium of the bar-code level 20, according to the invention the following formula is used to implement the imaging:
x=((c−X)(Yh−e)−(f−Y)(Xh−b))/((Yh−e)(Xg−a)−(Xh−b)(Yg−d)
y=((c−X)(Yg−d)−(f−Y)(Xg−a))/((Yg−d)(Xh−b)−(Xg−a)(Yh−e))

Conversion of the perspective of the image is essential in the decoding of the code, for example, a bar code. This is shown schematically in FIG. 3, in which the code 40 according to the trapezium is converted to a rectangular set of co-ordinates in the right-hand picture. The perspective conversion can be used in several ways, all of which are important in the decoding of a two-dimensional data-matrix code. These methods are:
1. Scaling. The accuracy of the image analysis will improve significantly, if the size of the data elements of the bar code is several image pixels.
2. Rotation. The image is rotated to be in accordance with a rectangular set of co-ordinates.
3. Perspective-transformation; This permits correction of a perspective error that would otherwise seriously impede decoding of the code, or even make it impossible.

For a successful conversion, it is important to estimate precisely the number of corner points. This is implemented by expressing the edge. This expression method utilizes a second derivative, the exceeding of zero.

A method, in which there is no positioning error (in the case of step edges), is used in the case of a two-dimensional matrix sign, to increase accuracy. In the case of a one-dimensional bar code, it is sufficient to use a simple derivation procedure.

According to FIG. 4, one interface of the invention's preferred mobile station 50 includes a display 55, on which there is an image 40 of the imaging subject and, in addition to this, an additional indicator 35, which can, in the case of a 1D code, be a horizontal line 35 that changes colour according to the image. A red colour of the line 35 indicates that the imaging event is in the preparation stage and the code has not yet been found. A change of colour in the line 35, for example, to yellow indicates that the code has been found and the analysis stage may have started. The change of the code to completely green indicates the successful interpretation. In addition to colour, a sound signal notifies of the successful interpretation of the code. The colour variations can be continuous, i.e. bright red—light red—light yellow—bright yellow—light green—bright green. An additional indicator 35 can naturally be, for example, a graphical sign, or a change in the colour of the entire display, or even a change in the display from black-and-white to coloured or vice versa. The most important aspect is to use a sign 35 to indicate to the user the stage of the process, in other words the state in which the user should keep the mobile station as completely stationary as possible.

According to one alternative embodiment of the invention, the additional indicator 35 is a coloured bar, which changes form red to yellow and green, depending on the quality of the image. Alternatively, there can also be a sign indicating the direction of the zooming, for example ‘Zoom in’ is a change from red to green. In the ‘Zoom out’ situation, the colour-change takes place in the opposite direction.

In a 2D case (matrix sign), a red box surround the centre-point of the sign 40, telling how large the sign should be. The colour coding is the same as in the 1D case.

Once the bar code has been interpreted, the system returns automatically to the bar-code search mode, after a specific delay.

When new camera-phone generations appear on the market, the use of low resolution in the code-search stage will not be absolutely necessary, due to their increased calculation capacity. On the other hand, the number of pixels of camera phones will also increase, which will increase the calculation requirement.

According to one preferred embodiment of the invention, polarizing filtering can be used in the camera's lens system, to reduce reflections.

The invention is typically implemented using a computer program stored in a data means to be run using a computer (the telephone's processor).

According to one preferred embodiment of the invention, a calculated quality indicator is defined in real time from each camera image, and depicts the probability that the bar code is in the image field and can be interpreted correctly, the quality indicator being calculated in the case of a 1D bar code from the variance of the grey tones of the horizontal lines of the image. In the case of a 2D bar code, the quality indicator is calculated form the variance of the grey tones of the image, the value of the quality indicator being shown to the user using coloured icons on the display of the phone, or by graphical signs, for example, in such a way that a lower probability is shown by read and a higher probability by yellow and green, and a high-resolution image is captured once the quality indicator of the bar code exceeds a set threshold value and the defined Line of Interest is interpreted in the low-resolution stage.

Further, one preferred embodiment of the invention includes means for indicating to the user, for example, by a sound signal, when the code sign 40 has been detected.

According to FIGS. 5-8, the display's indicator changes from the red of FIG. 5 through the orange of FIG. 6 and the green of FIG. 8, to the imaging-ready display of FIG. 8.

1. A method for detecting a code (40), in which method a mobile station (50) is used to capture an image of the subject (40) and the image is analysed and decoded into a numerical form in the mobile station (50),
characterized in that, before the decoding of the bar code in the mobile station
a calculated quality indicator is defined in real time from each camera image from the variance of the grey tones, which depicts the probability that the bar code is in the image field and can be interpreted correctly,
on the basis of the quality indicator, a decision is made as to whether the bar code is 1D or 2D,
in the case of a 1D bar code, the quality indicator is calculated from the Line of Interest, in which the differences between the grey tones along the line are greatest,
in the case of a 2D bar code, the quality indicator is calculated on the basis of the difference histogram of the grey tones of the image above the assumed bar code,
the value of the quality indicator is shown to the user on the display of the telephone, by using graphical signs, for example, in such a way that poorer visibility of the code is shown with red and higher visibility with yellow and green, and
a high-resolution image is captured once the quality indicator of the bar code exceeds a specified threshold level and the Line of Interest defined in the low-resolution stage is interpreted.

2. A method according to claim 1, characterized in that the subject is repeatedly imaged in low-resolution mode, using the mobile station (40), prior to the capture of the image to be analysed.

3. A method according to any of the above claims, characterized in that the interface is implemented in such a way that it instructs the user as to the stage in which the imaging situation is and how the user should proceed, so that on the basis of the instruction the user can easily set the camera telephone at the correct distance from the imaging subject.

4. A method according to claim 1 or 2, characterized in that, in the case of a 2D code, the image is rotated according to a rectangular set of co-ordinates before it is analysed.

5. A method according to any of the above claims, characterized in that an indication that a code sign (40) has been detected is given to the user, for example, with the aid of an icon and sound.

6. A method according to any of the above claims, characterized in that the optical signal coming to the camera is filtered using a polarization filter.

7. A method according to any of the above claims, characterized in that the software is arranged to control the lens arrangement of a camera telephone equipped with zoom optics, in such a way that the optimal magnification ratio is found automatically, thus further improving usability, because the user need not seek the correct imaging distance and it is sufficient for the code to be within the area of visibility of the camera.

8. A method for detecting a code (40), in which method a mobile station (50) is used to capture an image of the subject (40) and the image is analysed and decoded into a numerical form in the mobile station (50),
characterized in that before the decoding of the bar code in the mobile station
the edges of the subject (40) are determined from a high-resolution image,
in the case of a 2D code, the location of the corner point of the subject (40) are estimated on the basis of adaptive thresholding, and
a perspective transformation is formed in the case of a 2D code.

9. A method according to claim 9, characterized in that using the mobile station (50) the subject is repeatedly imaged in low-resolution mode prior to capturing the image to be analysed.

10. A method according to any of claims 8-9, characterized in that the interface is implemented in such a way that it instructs the user as to the stage in which the imaging situation is and how the user should proceed, so that on the basis of the instruction it is very easy for the user to set the camera telephone at the correct distance from the imaging subject.

11. A method according to any of claims 8-10, characterized in that, in the case of a 2D code, the image is rotated according to a rectangular set of co-ordinates before it is analysed.

12. A method according to any of claims 8-11, characterized in that an indication that a code sign (40) has been detected is given to the user, for example, with the aid of an icon and sound.

13. A method according to any of claims 8-12, characterized in that the optical signal coming to the camera is filtered using a polarization filter.

14. A method according to any of claims 8-13, characterized in that the software is arranged to control the lens arrangement of a camera telephone equipped with zoom optics, in such a way that the optimal magnification ratio is found automatically, thus further improving usability, because the user need not seek the correct imaging distance and it is sufficient for the code to be within the area of visibility of the camera.

15. A mobile station for detecting a code (40), which mobile station includes means for capturing an image of the subject (40) and means for analysing the subject (40) decoding it into a numerical form,
characterized in that the mobile station (50) includes means
for defining a quality indicator in real time from each camera image from the variance of the grey tones, which indicator depicts the probability that the bar code is in the image field and can be interpreted correctly,
in the case of a 1D bar code, for calculating a quality indicator from the variance of the grey tones of the horizontal lines of the image,
in the case of a 2D bar code, for calculating a quality indicator from the variance of the grey tones of the image,
for showing the value of the quality indicator to the user on the display of the telephone, by using graphical signs, for example, in such a way that poorer visibility of the code is shown with red and higher visibility with yellow and green, and
for capturing a high-resolution image once the quality indicator of the bar code exceeds a specified threshold level.

16. A mobile station according to claim 15, characterized it includes means for imaging the subject repeatedly in low-resolution mode, prior to the capture of the image to be analysed.

17. A mobile station according to any of the above claims, characterized in that it includes means for implementing the interface in such a way that it instructs the user as to the stage in which the imaging situation is and how the user should proceed, so that on the basis of the instruction the user can easily set the camera telephone at the correct distance from the imaging subject.

18. A mobile station according to any of the above claims, characterized in that, in the case of a 2D code, it includes means for rotating the image according to a rectangular set of co-ordinates before it is analysed.

19. A mobile station according to any of the above claims, characterized in that it includes means for indicating to the user, for example with a sound signal, once a code sign (40) has been detected.

20. A mobile station according to any of the above claims, characterized in that it includes a polarizing filter for filtering the optical signal coming to the camera, in order to avoid reflections.

21. A mobile station according to any of the above claims, characterized in that the software is arranged to control the lens arrangement of a camera telephone equipped with zoom optics, in such a way that the optimal magnification ratio is found automatically, thus further improving usability, because the user need not seek the correct imaging distance and it is sufficient for the code to be within the area of visibility of the camera.

22. A mobile station for detecting a code (40), which mobile station includes means for capturing an image of the subject (40) and means for analysing the subject (40) and decoding it into a numerical form,
characterized in that the mobile station (50) includes means
for determining the edges of the subject (40) from a high-resolution image,
in the case of a 2D code, for estimating the location of the corner point of the subject (40) on the basis of adaptive thresholding, and
for forming a perspective transformation in the case of a 2D code.

23. A computer program product, to be stored on a memory medium and to be run using a computer, for implementing the mobile station, or method according to any of the above claims.
